(19) United States
(12) Patent Application Publication
(10) Pub. No.: US 2026/0064177 A1
(43) Pub. Date: Mar. 5, 2026

(54) ELECTRICAL POWER CONTROL DEVICES AND RELATED METHODS

(71) Applicant: ABB SCHWEIZ AG, Baden (CH)

(72) Inventors: Abhinav Patni, Raleigh, NC (US); Alexandre Santerre, Saint-Jean sur Richelieu (CA); Govind Chavan, Garner, NC (US); Vincent Beaumont, Saint-Jean sur Richelieu (CA)

(21) Appl. No.: 18/824,873

(22) Filed: Sep. 4, 2024

(51) Int. Cl. G06F 1/26; G06F 1/3215

(52) U.S. Cl. CPC G06F 1/266; G06F 1/3215

(57) ABSTRACT

Electrical power control devices may include a main power connection for transmitting electrical power to a disconnect panel and an auxiliary power connection for transmitting electrical power to an auxiliary device, at least one current sensor configured to sense a total electrical current passing through the main power connection and the auxiliary power connection, and a relay may be coupled to the auxiliary power connection. The relay may be configured to open to stop flow of auxiliary electrical current through the auxiliary power connection after the total electrical current is above a predetermined safety threshold and to close to allow flow of the electrical current through the auxiliary power connection immediately after the total current reaches a predetermined reconnection threshold lower than the predetermined safety threshold. Various other related devices, systems, and methods are also disclosed.

### BACKGROUND

The increasing popularity of electric vehicles (EVs) or other auxiliary electrical devices has led to a rise in energy use in homes. This higher power usage, including from homes with EV chargers, can benefit from electrical power data monitoring. Such monitoring systems may be helpful in comprehending energy use patterns and improving overall consumption. The data obtained can offer homeowners useful details about their energy use, allowing them to better control power and balance between everyday electricity needs and auxiliary demands (e.g., EV charging demands). Higher energy bills can often result from increased electrical loads, making power data monitoring a helpful consideration for homeowners who have auxiliary electrical needs. These monitoring systems can also support utility companies in handling grid load more efficiently, helping avoid power outages or fluctuations that could disrupt service.

### BRIEF SUMMARY

In some aspects, the techniques described herein relate to an electrical power control device, including: a main power connection for transmitting electrical power to a disconnect panel; an auxiliary power connection for transmitting electrical power to an auxiliary device; at least one current sensor configured to sense a total electrical current passing through the main power connection and the auxiliary power connection; and a relay coupled to the auxiliary power connection, wherein the relay is configured to: open to stop flow of auxiliary electrical current through the auxiliary power connection after the total electrical current is above a predetermined safety threshold; and close to allow flow of the electrical current through the auxiliary power connection immediately after the total current reaches a predetermined reconnection threshold lower than the predetermined safety threshold.

In some aspects, the techniques described herein relate to a device, wherein the relay is configured to open after: waiting a predetermined time after the total electrical current is above the predetermined safety threshold; and after waiting the predetermined time, the total electrical current is still above the predetermined safety threshold.

In some aspects, the techniques described herein relate to a device, wherein the predetermined time is less than one minute.

In some aspects, the techniques described herein relate to a device, wherein the predetermined time is less than 10 seconds.

In some aspects, the techniques described herein relate to a device, further including a logic circuit connected to the at least one current sensor and the relay, the logic circuit being configured to selectively cause the relay to open and close based on data from the at least one current sensor.

In some aspects, the techniques described herein relate to a device, wherein the logic circuit includes digital logicNC gates implemented without a controller.

In some aspects, the techniques described herein relate to a device, wherein the logic circuit is implemented via a controller programmed to receive data from the at least one current sensor and to control operation of the relay.

In some aspects, the techniques described herein relate to a device, further including a controller configured to: receive data from the at least one current sensor indicative of the total electrical current; instruct the auxiliary device to reduce its power consumption after the total electrical current is above the predetermined safety threshold and prior to the relay opening to stop the flow of the auxiliary electrical current through the auxiliary power connection; and cause the relay to open and close based on the data indicative of the total electrical current.

In some aspects, the techniques described herein relate to a device, wherein the at least one current sensor includes: a main current sensor coupled to the main power connection for sensing electrical current passing through the main power connection; and an auxiliary current sensor coupled to the auxiliary power connection for sensing electrical current passing through the auxiliary power connection.

In some aspects, the techniques described herein relate to a device, wherein a difference between the predetermined safety threshold and the predetermined reconnection threshold is greater than a maximum ampacity rating of the auxiliary power connection.

In some aspects, the techniques described herein relate to a device, further including a housing containing the at least one current sensor and the relay.

In some aspects, the techniques described herein relate to a device, wherein the housing further contains a meter socket.

In some aspects, the techniques described herein relate to a device, wherein the housing is mounted external to a meter socket supplying electrical power to the electrical power control device.

In some aspects, the techniques described herein relate to a device, wherein the auxiliary device includes at least one of: an electric vehicle charging station; an electric vehicle, a pump; an air conditioning unit; a heater; or a refrigerator.

In some aspects, the techniques described herein relate to a device, wherein the disconnect panel includes at least one of: a residential breaker panel; a commercial breaker panel; a fuse box; a fusible switch box; or a protective relay panel.

In some aspects, the techniques described herein relate to an electrical power control system, including: at least one current sensor configured to sense a total electrical current passing through a main power connection to a disconnect panel and an auxiliary power connection to an auxiliary device; a relay coupled to the auxiliary power connection; and a logic circuit, wherein the logic circuit is configured to: perform a first comparison to determine whether the total electrical is equal to or greater than a predetermined safety threshold; when the total electrical current is equal to or greater than the predetermined safety threshold, wait a predetermined time; after the predetermined time, perform a second comparison to determine whether the total electrical current is equal to or greater than the predetermined safety threshold; and when the second comparison determines that the total electrical current is equal to or greater than the predetermined safety threshold, open or keep open the relay to stop flow of electrical current to the auxiliary device.

In some aspects, the techniques described herein relate to a system, wherein the logic circuit is further configured to: when the second comparison determines that the total electrical current does not meet or exceed the predetermined safety threshold, perform a third comparison to determine whether the total electrical current is less than or equal to a predetermined reconnection threshold less than the predetermined safety threshold; and when the third comparison determines that the total electrical current is equal to or less than the predetermined reconnection threshold, close or keep closed the relay to allow flow of electrical current to the auxiliary device.

In some aspects, the techniques described herein relate to a system, wherein the predetermined time is less than one minute.

In some aspects, the techniques described herein relate to a system, wherein the logic circuit is implemented via one of: digital logic gates without a controller; or a controller programmed to receive data from the at least one current sensor and to control operation of the relay.

In some aspects, the techniques described herein relate to a method of forming an electrical power control device, the method including: coupling at least one current sensor to a main power connection for transmitting electrical power from a meter socket to a disconnect panel and to an auxiliary power connection for transmitting electrical power from the meter socket to an auxiliary device; coupling a relay to the auxiliary power connection; and coupling a logic circuit to the at least one current sensor and to the relay, wherein the logic circuit is configured to: open the relay when a total electrical current through the main power connection and the auxiliary power connection reaches a predetermined safety threshold and remains above the predetermined safety threshold after a predetermined time; and immediately close the relay when the total electrical current drops below a predetermined reconnection threshold below the predetermined safety threshold.

### BRIEF DESCRIPTION OF THE DRAWINGS

FIG. 1 is a schematic diagram of a power supply system that includes an electrical power control device, according to at least one embodiment of the present disclosure.

FIG. 2 is a schematic diagram of a power supply system that includes an electrical power control device, according to at least one additional embodiment of the present disclosure.

FIG. 3 is a schematic diagram of a power supply system that includes an electrical power control device, according to at least one further embodiment of the present disclosure.

FIG. 4 is a schematic diagram of a power supply system that includes an electrical power control device, according to at least one additional embodiment of the present disclosure.

FIG. 5 is a flow diagram illustrating a method of operating an electrical power control device, according to at least one embodiment of the present disclosure.

FIG. 6A is a plot of current over time in a first scenario, and FIG. 6B is a plot of current over time in a second scenario, according to embodiments of the present disclosure.

FIG. 7 is a flow diagram illustrating a method of forming an electrical power control device, according to at least one embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure provides detailed descriptions of electrical power control devices that can manage the electrical power usage of systems that include a main branch (e.g., to a main disconnect panel and associated devices) and an auxiliary branch for one or more auxiliary devices. As will be explained in greater detail below, some embodiments of the present disclosure may include a main power connection for transmitting electrical power to a disconnect panel and an auxiliary power connection for transmitting electrical power to an auxiliary device. At least one current sensor may be configured to sense a total electrical current passing through the main power connection and the auxiliary power connection. A relay may be coupled to the auxiliary power connection. The relay may be configured to open to stop flow of auxiliary electrical current through the auxiliary power connection after the total electrical current is above a predetermined safety threshold and to close to allow flow of the electrical current through the auxiliary power connection immediately after the total current reaches a predetermined reconnection threshold lower than the predetermined safety threshold. Such devices may be helpful to reduce a chance of a disconnect (e.g., breaker, fuse, etc.) tripping by automatically shutting off one or more auxiliary devices prior to the disconnect tripping, inhibiting overload in the system as a whole during times of high electricity demand. Such devices may also be helpful to restore power to an auxiliary device after disconnected to reduce downtime of the auxiliary device during times of high electricity demand.

Features from any of the embodiments described herein may be used in combination with one another in accordance with the general principles described herein. These and other embodiments, features, and advantages will be more fully understood upon reading the following detailed description in conjunction with the accompanying drawings and claims.

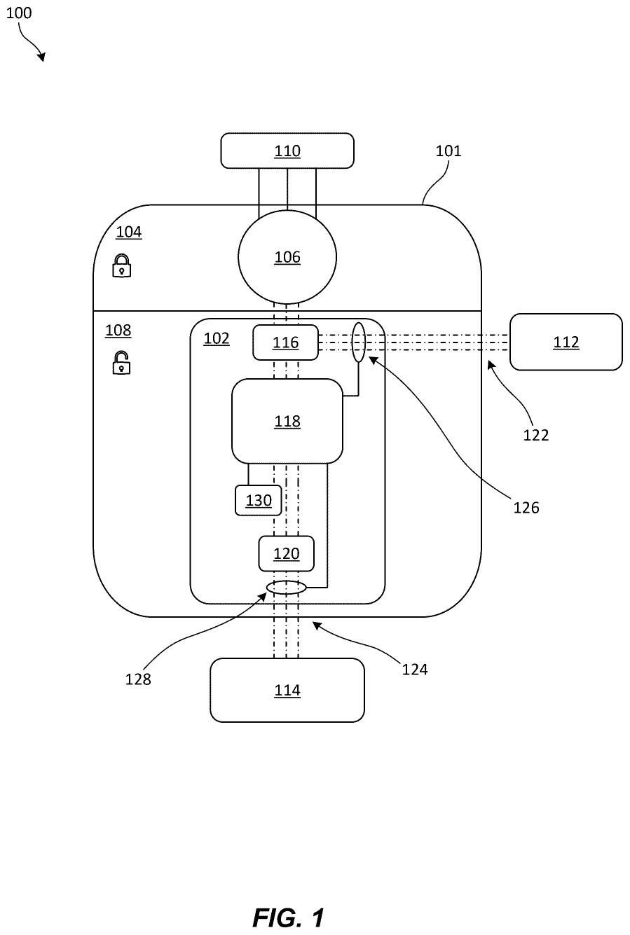

FIG. 1 is a schematic diagram of a power supply system 100 that includes an electrical power control device 102, according to at least one embodiment of the present disclosure. The power supply system 100 may be in the form of an expanded meter socket 101 that includes the electrical power control device 102.

For example, expanded meter socket 101 may be a multi-compartment meter socket 101 including a meter socket section 104 that houses a power meter 106 and a power control section 108 that houses the electrical power control device 102. In some embodiments, the meter socket section 104 may be locked or otherwise access-limited (e.g., for access only by personnel authorized by a power company), such as to inhibit tampering and/or theft of electrical power and for safety. The power control section 108 may be accessible by a user and/or electrician (e.g., without authorization by a power company), such as for installation, maintenance, modification, etc.

The power supply system 100 may be connected at an input side to a utility grid 110 for providing power to the power supply system 100, through the electrical power control device 102, and ultimately to a user's electrical systems, such as to a disconnect panel 112 (e.g., a residential breaker panel, a commercial breaker panel, a fuse box, a fusible switch box, a protective relay panel, etc.) and/or to an auxiliary device 114. In the example shown in FIG. 1, the utility grid 110 may provide a single-phase (e.g., three-wire) alternating current (AC) power supply including at least a hot wire and a neutral wire. In additional examples, the utility grid 110 may be a two-wire AC power supply or a four-wire AC power supply. The AC power supply from the utility grid 110 may be a single-phase (e.g., split-phase) AC power supply or a three-phase AC power supply.

Power from the utility grid 110 may pass through the power meter 106 for measuring total electrical power usage through the disconnect panel 112 and the auxiliary device 114. An output side of the power meter 106 may be operably connected to a power input of the electrical power control device 102, such as via suitable conductors (e.g., cables, wires, traces, etc.).

The electrical power control device 102 may include an input disconnect 116, a data collection and control module 118, and an auxiliary disconnect 120. A main power connection 122 of the electrical power control device 102 may be capable of transmitting electrical power from the electrical power control device 102 to the disconnect panel 112. An auxiliary power connection 124 of the electrical power control device 102 may be capable of transmitting electrical power from the electrical power control device 102 to and/or from the auxiliary device 114.

The input disconnect 116 may be positioned between the power meter 106 and the data collection and control module 118 and between the power meter 106 and the disconnect panel 112. In some embodiments, the input disconnect 116 may be rated with a sufficiently high amperage to supply full power to both the disconnect panel 112 and the auxiliary device 114. In other words, the current rating of the input disconnect 116 may be at least as high as the combination of the disconnect panel 112 rating and of the auxiliary device 114 rating, such as to reduce instances of the input disconnect 116 inadvertently opening and halting service to both the disconnect panel 112 and to the auxiliary device 114.

The auxiliary disconnect 120 may be positioned between the data collection and control module 118 and the auxiliary device 114. The auxiliary disconnect 120 may be configured to interrupt service to or from the auxiliary device 114 for installation or maintenance, in case of a fault (e.g., short-circuit) in the auxiliary device 114, for installation or maintenance of the data collection and control module 118, etc.

As will be explained further below, the data collection and control module 118 may be configured to sense at least one first electrical characteristic of the main power connection 122 and at least one second electrical characteristic of the auxiliary power connection 124. For example, the electrical power control device 102 may include at least one main sensor 126 for sensing the first electrical characteristic of the main power connection 122 and at least one auxiliary sensor 128 for sensing the second electrical characteristic of the auxiliary power connection 124. By way of example and not limitation, each of the at least one main sensor 126 and the at least one auxiliary sensor 128 may be in the form of an inductive sensor, a current shunt sensor, a Hall effect-based sensor, a fluxgate sensor, and/or a Rogowski principle-based sensor (e.g., a Rogowski coil sensor).

The data collection and control module 118 may be in the form of a printed circuit board (PCB) that includes at least an analog-to-digital converter for processing signals from the at least one main sensor 126 and at least one auxiliary sensor 128 and a control module for controlling a flow of electrical current to at least the auxiliary device 114. In some examples, the data collection and control module 118 may also include a communication module for communicating information based on the signals to a user device or other recipient. One or more of these components of the data collection and control module 118 may be implemented via one or more controllers (e.g., microcontrollers), signal processing components, transistors, transceivers, etc. For example, a controller of the data collection and control module 118 may be configured to receive data from the at least one main sensor 126 and/or at least one auxiliary sensor 128 indicative of the total current passing through the main power connection 122 and/or the auxiliary power connection 124. The controller may also be configured to cause changes to current usage of the auxiliary device 114, such as through opening and/or closing a relay and/or instructing the auxiliary device 114 to reduce its power consumption, as described further below.

In some examples, relational terms, such as “first,” “second,” etc., may be used for clarity and convenience in understanding the disclosure and accompanying drawings and do not connote or depend on any specific preference, orientation, or order, except where the context clearly indicates otherwise.

In some embodiments, the first electrical characteristic and the second electrical characteristic may include current and/or voltage, and/or a characteristic derived from current and/or voltage (e.g., power). The data collection and control module 118 may also be configured to communicate the first and second electrical characteristic, or information based on the first and second electrical characteristic, to a user device or other recipient. For example, the main sensor 126 may be or include a first current sensor for sensing an electrical current in the main power connection 122 and the auxiliary sensor 128 may be or include a second current sensor for sensing an electrical current in the auxiliary power connection 124.

The auxiliary device 114 may be one or more devices that use electrical power. Examples of the auxiliary device 114 include an electric vehicle (EV) charging station, an electric vehicle, a pump, an air conditioning unit, a heater, a refrigerator, etc. Other devices that draw electrical power may also be considered auxiliary devices 114. In additional embodiments of the present disclosure, the auxiliary device 114 may generate electricity, and the auxiliary power connection 124 may operate as an input, such as for providing electrical power to the disconnect panel 112. For example, the auxiliary device 114 may be or include a wind turbine, a water turbine, a thermal power generator, a gas generator, a solar panel, etc. Accordingly, the at least one auxiliary sensor 128 can, in some embodiments, be used to obtain electrical characteristic data regardless of the direction that electrical current flows in the auxiliary power connection 124.

In some embodiments, the electrical power control device 102 may also include a relay 130 operably coupled to at least a portion of the auxiliary power connection 124, such as a hot wire of the auxiliary power connection 124. The relay 130 may be configured to open to stop flow and/or close to allow flow of at least some electrical current through the auxiliary power connection 124 (e.g., to stop flow of the electrical current through the hot wire of the auxiliary power connection 124). For example, the relay 130 may be configured to open in response to the data collection and control module 118 determining that a total current through the main power connection 122 and through the auxiliary power connection 124 meets or exceeds a predetermined safety threshold (e.g., a threshold between 50 percent and 95 percent of a maximum ampacity rating of the power supply system 100, between 70 percent and 95 percent of the maximum ampacity rating, such as 80 percent of the maximum ampacity rating). The relay 130 may also be configured to close in response to the data collection and control module 118 determining that the total current through the main power connection 122 and through the auxiliary power connection 124 meets or falls below a predetermined reconnection threshold (e.g., equal to or less than the predetermined safety threshold, such as between 40 percent and 90 percent of the maximum ampacity rating of the power supply system 100). Further examples and details relating to decision-making for opening and closing the relay 130 are explained below.

FIG. 1 illustrates a single auxiliary device 114. However, the present disclosure is not so limited. In additional examples, the auxiliary device 114 may represent multiple auxiliary devices 114 connected to the electrical power control device 102. In embodiments in which multiple auxiliary devices 114 are used, a single relay 130 may be used to stop at least some electrical current flow to all auxiliary devices 114 when the predetermined safety threshold is met or exceeded, or a respective relay 130 may be employed for each of the auxiliary devices 114 to selectively stop at least some electrical current flow to one or more of the auxiliary devices 114.

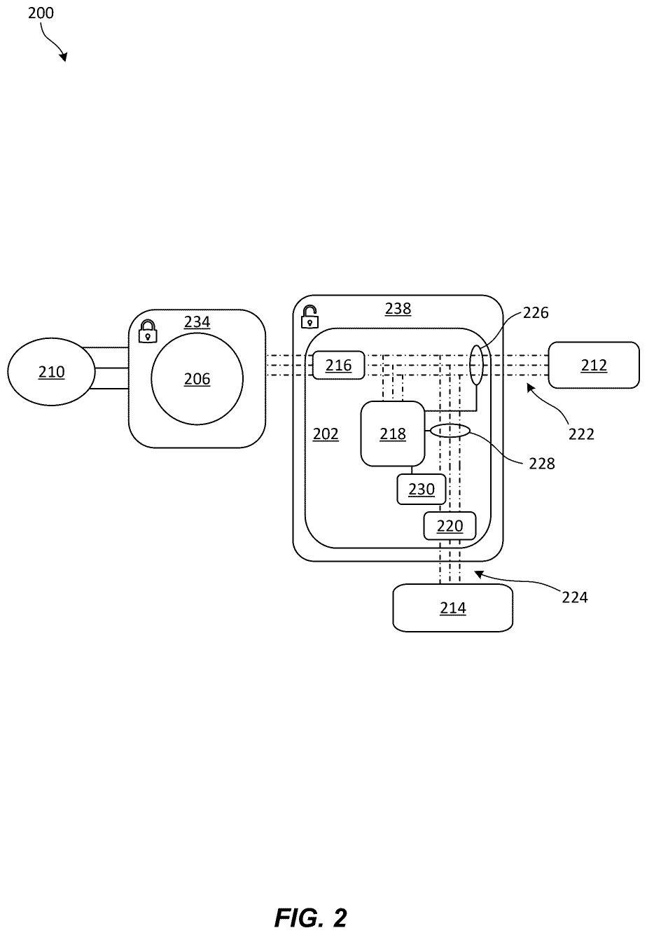

FIG. 2 is a schematic diagram of a power supply system 200 that includes an electrical power control device 202, according to at least one additional embodiment of the present disclosure.

In some respects, the power supply system 200 of FIG. 2 may be similar to the power supply system 100 illustrated in FIG. 1. For example, the power supply system 200 of FIG. 2 may include a power meter 206 that receives electrical power from a utility grid 210, a disconnect panel 212, an auxiliary device 214, and the electrical power control device 202 that is configured to monitor electrical characteristics of a main power connection 222 to the disconnect panel 212 and of an auxiliary power connection 224 to the auxiliary device 214, such as via a main sensor 226 and/or an auxiliary sensor 228. The electrical power control device 202 may include an input disconnect 216, a data collection and control module 218, and an auxiliary disconnect 220. The electrical power control device 202 may also include a relay 230 configured to open to stop flow of at least some electrical current through the auxiliary power connection 224 (e.g., to stop flow of the electrical current through a hot wire of the auxiliary power connection 224) when a predetermined safety threshold is met or exceeded.

Referring to FIG. 2, the power supply system 200 may include a meter socket 234 containing the power meter 206 that is external to (e.g., physically separate from) a housing 238 that contains the electrical power control device 202. In some examples, the housing 238 and electrical power control device 202 therein may be mounted adjacent to (e.g., along a same wall as) the meter socket 234. In additional examples, the housing 238 and electrical power control device 202 may be mounted remotely from the meter socket 234, such as adjacent to the auxiliary device 214 or adjacent to the disconnect panel 212.

Accordingly, referring to FIGS. 1 and 2, electrical power control devices 102, 202 of the present disclosure may be implemented as part of an expanded meter socket 101 or via a housing 238 that is separate from a meter socket 234. The functional components of the electrical power control devices 102, 202 may be the same or similar in either case.

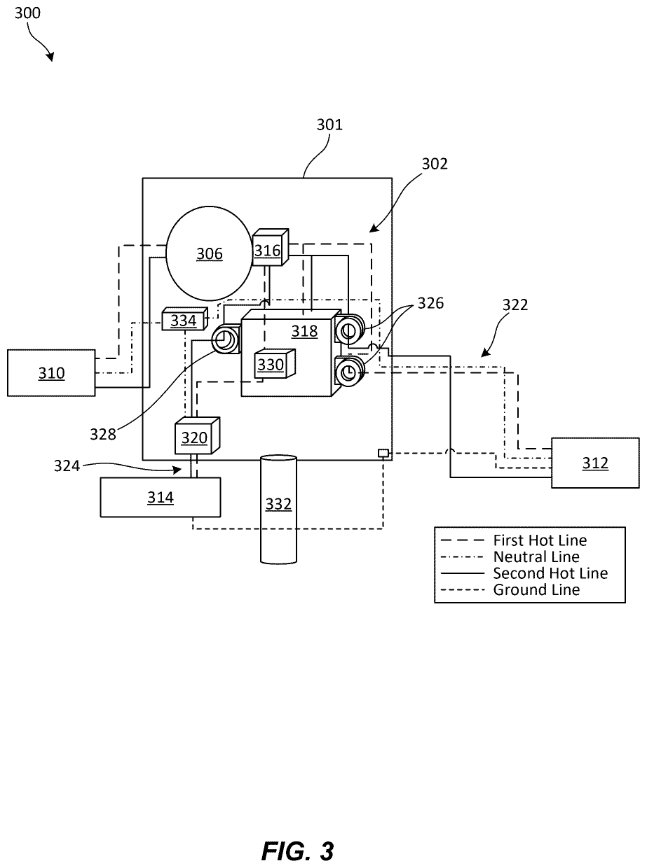

FIG. 3 is a schematic diagram of a power supply system 300 that includes an electrical power control device 302, according to at least one further embodiment of the present disclosure.

In some respects, the power supply system 300 of FIG. 3 may be similar to the power supply system 100 illustrated in FIG. 1. For example, the power supply system 300 of FIG. 3 may include a power meter 306 that receives electrical power from a utility grid 310, a disconnect panel 312, an auxiliary device 314, and the electrical power control device 302 that is configured to monitor electrical characteristics of a main power connection 322 to the disconnect panel 312 and of an auxiliary power connection 324 to the auxiliary device 314, such as via one or more main sensors 326 and/or an auxiliary sensor 328. The power supply system 300 may be implemented in the form of an expanded meter socket 301. The electrical power control device 302 may include an input disconnect 316, a data collection and control module 318, and an auxiliary disconnect 320. The electrical power control device 302 may also include a relay 330 configured to open to stop flow of at least some electrical current through the auxiliary power connection 324 (e.g., to stop flow of the electrical current through at least one hot wire of the auxiliary power connection 324) when a predetermined safety threshold is met or exceeded. The relay 330 may also be configured to close to allow flow of at least some electrical current through the auxiliary power connection 324 when a predetermined reconnection threshold is met.

In FIG. 3, the power supply system 300 is illustrated as a split-phase alternating-current (AC) system. Long dashed connector lines represent a first hot line, dash-dot lines represent a neutral line, solid lines represent a second hot line, and short dashed lines represent a ground line. Components of the power supply system 300 may be operably coupled to one, two, three, or four of these lines, such as depending on their electrical operating characteristics (e.g., designed operating voltage, current, phase, grounding requirements, etc.). The ground line may be electrically coupled to a ground rod 332 or other grounded conductive element, which may in turn be electrically coupled to a housing (e.g., a metal box) of the expanded meter socket 301. The neutral line may be electrically coupled to a neutral lug 334 positioned in the expanded meter socket 301.

In various embodiments of the present disclosure, the power supply system 300 may be a single-phase power system, a split-phase power system, a three-phase power system, a hybrid system, etc.

For example, the data collection and control module 318 may collect and monitor data from the one or more main sensors 326 indicative of a first electrical current passing through the main power connection 322 to the disconnect panel 312, as well as data from the auxiliary sensor 328 indicative of a second electrical current passing through the auxiliary power connection 324 to the auxiliary device 314. Based on this data, the data collection and control module 318 may cause the relay 330 to open or close to respectively stop or allow the flow of electrical current through one or more hot wires of the auxiliary power connection 324. As illustrated in FIG. 3, the relay 330 may, in some embodiments, be operably coupled to one of two hot wires of the auxiliary power connection 324. In additional examples, a single relay or two respective relays may be operably coupled to two hot wires of the auxiliary power connection 324.

For example, if the combination of the first electrical current and the second electrical current reaches a predetermined safety threshold, the data collection and control module 318 may cause the relay 330 to open to stop flow of at least some of the electrical current passing through the auxiliary power connection 324. By way of example and not limitation, the predetermined safety threshold may be between 50 percent and 95 percent of a maximum ampacity rating of the meter socket, such as between 70 percent and 95 percent of the maximum ampacity rating, such as about 80 percent of the maximum ampacity rating. For example, the maximum ampacity rating may be in a range of 100 amps to 400 amps, although other maximum ampacity ratings may be possible in additional situations.

After the relay 330 is opened, reconnection may occur when the combination of the first electrical current and the second electrical current reaches a predetermined reconnection threshold. The predetermined reconnection threshold may be lower than the predetermined safety threshold. For example, the predetermined reconnection threshold may be between about 40 percent and about 90 percent of the maximum ampacity rating of the meter socket, such as about 70 percent of the maximum ampacity rating when the predetermined safety threshold is 80 percent of the maximum ampacity rating. In additional examples, the predetermined reconnection threshold may be 75 percent and the predetermined safety threshold may be 80 percent of the maximum ampacity rating.

In the example shown in FIG. 3, two main sensors 326 are illustrated for measuring an electrical current through the respective first hot line and second hot line. While the electrical current level through the first hot line may be similar to the electrical current through the second hot line, these current levels may not always be identical at any specific time. For determining whether the predetermined safety threshold and/or the predetermined reconnection threshold is met, the data collection and control module 318 may use a highest value for the two main sensors 326 for increased safety.

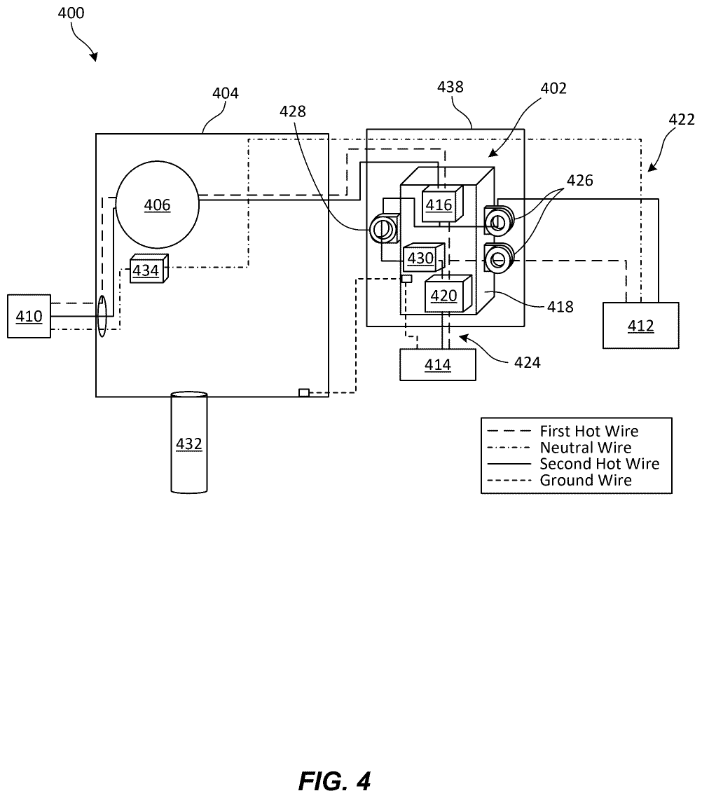

FIG. 4 is a schematic diagram of a power supply system 400 that includes an electrical power control device 402, according to at least one additional embodiment of the present disclosure.

In some respects, the power supply system 400 of FIG. 4 may be similar to the power supply system 200 illustrated in FIG. 2. For example, the power supply system 400 of FIG. 4 may include a power meter 406 that receives electrical power from a utility grid 410, a disconnect panel 412, an auxiliary device 414, and the electrical power control device 402 that is configured to monitor electrical characteristics of a main power connection 422 to the disconnect panel 412 and of an auxiliary power connection 424 to the auxiliary device 414, such as via one or more main sensors 426 and/or an auxiliary sensor 428. The electrical power control device 402 may be contained in a housing 438 that is separate from a meter socket 404 that contains the power meter 406.

The electrical power control device 402 may include an input disconnect 416, a data collection and control module 418, and an auxiliary disconnect 420. The electrical power control device 402 may also include a relay 430 configured to open to stop flow of at least some electrical current through the auxiliary power connection 424 (e.g., to stop flow of the electrical current through at least one hot wire of the auxiliary power connection 424) when a predetermined safety threshold is met or exceeded. The relay 430 may also be configured to close to allow flow of at least some electrical current through the auxiliary power connection 424 when a predetermined reconnection threshold is met.

A ground rod 432 or other grounded conductive element may be electrically coupled to a housing of the meter socket 404 and/or to the housing 438 that contains the electrical power control device 402.

The data collection and control module 418 may collect and monitor data from the one or more main sensors 426 indicative of a first electrical current passing through the main power connection 422 to the disconnect panel 412, as well as data from the auxiliary sensor 428 indicative of a second electrical current passing through the auxiliary power connection 424 to the auxiliary device 414. Based on this data, the data collection and control module 418 may cause the relay 430 to open or close to respectively stop or allow the flow of electrical current through one or more hot wires of the auxiliary power connection 424. For example, the data collection and control module 418 may cause the relay 430 to respectively open and close when the total electrical current passing through the main power connection 422 and auxiliary power connection 424 reaches the predetermined safety threshold and the predetermined reconnection threshold.

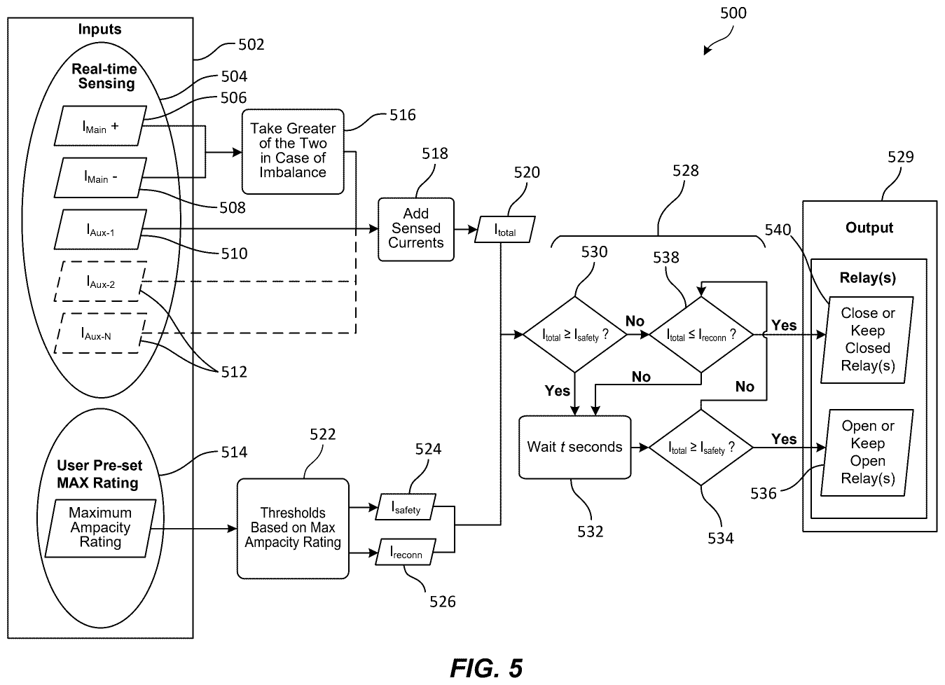

FIG. 5 is a flow diagram illustrating a method 500 of operating an electrical power control device, according to at least one embodiment of the present disclosure. The method 500 may be implemented by a power supply system, such as any of the power supply systems 100, 200, 300, 400 described above.

At operation 502, various inputs may be received by the power supply system. For example, real-time sensing 504 of a first main current 506 (e.g., through a first hot wire of a main power connection), second main current 508 (e.g., through a second hot wire of the main power connection), and auxiliary current 510 (e.g., through a hot wire of an auxiliary power connection) may be performed, such as by respective electrical current sensors. Optionally, if more than one auxiliary device is present, real-time sensing 504 of one or more additional auxiliary currents 512 may also be performed.

A user pre-set maximum rating 514 may also be an input received by the power supply system. The maximum rating 514 may be based on a maximum ampacity rating of a meter socket through which electrical power is provided to a house or commercial establishment. The maximum ampacity rating may be determined based on indications from a manufacturer of the meter socket and/or from a utility supplier. For example, the maximum ampacity rating may be in a range of 20 amps to 400 amps, such as 20 amps, 80 amps, 100 amps, 160 amps, 200 amps, 320 amps, or 400 amps. The maximum ampacity rating may be set by a user during installation of the power supply system or at a later time, such as via toggling a physical switch or by entering or selecting the maximum ampacity rating via a software interface.

At operation 516, the first main current 506 and the second main current 508 may be compared to determine which is greater in case there is an imbalance between the two. The greater of the two currents may be used for increased safety in the power supply system.

At operation 518, the greater main current 506 or 508 may be added to the auxiliary current 510 (and any additional auxiliary currents 512, if applicable) to obtain a total current 520 passing through the power supply system.

At operation 522, thresholds based on the maximum ampacity rating 514 may be determined. For example, a predetermined safety threshold 524 may be between 50 percent and 95 percent of the maximum ampacity rating 514, such as between 70 percent and 95 percent of the maximum ampacity rating 514, such as about 80 percent of the maximum ampacity rating 514. The percentage of the predetermined safety threshold 524 as compared to the maximum ampacity rating 514 may be selected by a user or may be pre-set. A predetermined reconnection threshold 526 may be less than the predetermined safety threshold 524, such as between about 40 percent and 90 percent of the maximum ampacity rating 514. The percentage of the predetermined reconnection threshold 526 as compared to the maximum ampacity rating 514, and/or as compared to the predetermined safety threshold 524, may be selected by a user or may be pre-set.

In some examples, a difference between the predetermined safety threshold 524 and the predetermined reconnection threshold 526 may be greater than a maximum ampacity rating of an auxiliary power connection (e.g., to supply the auxiliary current 510 and/or the one or more additional auxiliary currents 512). For example, the difference between the predetermined safety threshold 524 and the predetermined reconnection threshold 526 may be set as the maximum ampacity rating of the auxiliary power connection plus a buffer. By way of example and not limitation, the buffer may be between 1 amp and 50 amps. By making the difference between the predetermined safety threshold 524 and the predetermined reconnection threshold 526 greater than the maximum ampacity rating of the auxiliary power connection, instances of frequently shutting off and on the auxiliary current 510 and/or the one or more additional auxiliary currents 512 may be reduced.

The method 500 may include a multi-check process 528 to determine which output 529 to perform, including to open or keep open relay(s) 536 to one or more auxiliary devices (e.g., to supply the auxiliary current 510 and/or the one or more additional auxiliary currents 512) or to close or keep closed the relay(s) 540 to the one or more auxiliary devices (e.g., to cut off the auxiliary current 510 and/or the one or more additional auxiliary currents 512). For example, at query 530, the system may perform a first comparison to determine whether the total current 520 is greater than or equal to the predetermined safety threshold 524.

If the answer to query 530 is yes, then the system may wait a predetermined time, such as t seconds, at operation 532 before taking further action. By way of example, the amount of waiting at operation 532 may be less than one minute. In additional examples, the amount of waiting at operation 532 may be less than 30 seconds, such as less than 10 seconds, 5 seconds or less, 4 seconds or less, 3 seconds or less, 2 seconds or less, or 1 second or less.

After waiting for the predetermined time at operation 532, at query 534 the system may perform a second comparison to determine whether the total current 520 is greater than or equal to the predetermined safety threshold 524. If the answer to query 534 is yes, then the system may open (if closed) or keep open (if already open) the relay(s) 536.

By performing operation 532 to wait t seconds and confirming that the total current 520 is again above the predetermined safety threshold 524, the system may ensure that the total current 520 is above the predetermined safety threshold 524 before opening or keeping open the relay(s) 536. Additionally, performing operation 532 to wait t seconds may reduce instances of prematurely shutting off the auxiliary current 510 and/or the one or more additional auxiliary currents 512, such as in cases where the total current 520 is rising slightly above and falling below the predetermined safety threshold 524 due to a variable current load, or the total current 520 only briefly rises above the predetermined safety threshold 524.

Returning again to query 534, if the total current 520 is not greater than or equal to the predetermined safety threshold 524, then the system may perform query 538 to perform a third comparison to determine whether the total current 520 is less than or equal to the predetermined reconnection threshold 526.

If the answer to query 538 is no, then the total current 520 may have dropped between the predetermined safety threshold 524 and the predetermined reconnection threshold 526. In this state, the system may again perform operation 532 to wait t seconds before taking further action, including checking again whether the total current 520 has reached or exceeded the predetermined safety threshold 524 at query 534. This loop of comparing the total current 520 to the predetermined safety threshold 524 at query 534, comparing the total current 520 to the predetermined reconnection threshold 526 at query 538, and waiting t seconds at operation 532 may continue until the total current 520 again reaches or exceeds the predetermined safety threshold 524 or reaches or drops below the predetermined reconnection threshold 526.

Returning again to query 538, if the total current 520 is less than or equal to the predetermined reconnection threshold 526, then the system may close (if open) or keep closed (if already closed) the relay(s) 540. In some embodiments of the present disclosure, one or more open relays may be closed immediately after affirmatively determining that the total current 520 is less than or equal to the predetermined reconnection threshold 526, without first waiting a period of time. Compared to systems that wait a period of time (e.g., several seconds to many minutes) before reconnecting or otherwise re-energizing an auxiliary device, the feature of closing the open relay(s) immediately after determining that the total current 520 is less than or equal to the predetermined reconnection threshold 526 may reduce downtime of the auxiliary device.

Returning again to query 530, if the total current 520 is not greater than or equal to the predetermined safety threshold 524 after the initial check, then the multi-check process 528 may proceed to query 538 to determine whether the total current 520 is less than or equal to the predetermined reconnection threshold 526. Yes or no answers to query 538 may cause the system to proceed as outlined above and as shown in FIG. 5.

In some embodiments, the multi-check process 528 may be performed by a logic circuit configured to make the queries 530, 534, 538, perform the operation 532, and/or cause the output 529. In some examples, the logic circuit may include digital logic gates (e.g., AND gates, OR gates, NAND gates, NOR gates, XOR gates, XNOR gates, combinations thereof, etc.) implemented without a controller (e.g., a microcontroller). For example, the digital logic gates may be implemented via transistors, switches, diodes, resistors, relays, field-programmable gate arrays (FPGAs), combinations thereof, etc. In additional examples, the logic circuit may be implemented via a controller (e.g., microcontroller) programmed to receive data from the real-time sensing 506 (e.g., from at least one current sensor) and to control operation of the relay(s).

The output 529 may be performed automatically in response to the system sensing the electrical currents and comparing those to the predetermined thresholds as outlined above. By automatically opening and closing the auxiliary relay(s) to manage the flow of electrical current to one or more auxiliary devices, the main electrical current flow to a disconnect panel may not be interrupted even during periods of high electrical demand. In addition, the chance of disconnects (e.g., breakers and/or fuses) tripping may be considerably less, which may reduce the need for a consumer to manually correct those interruptions.

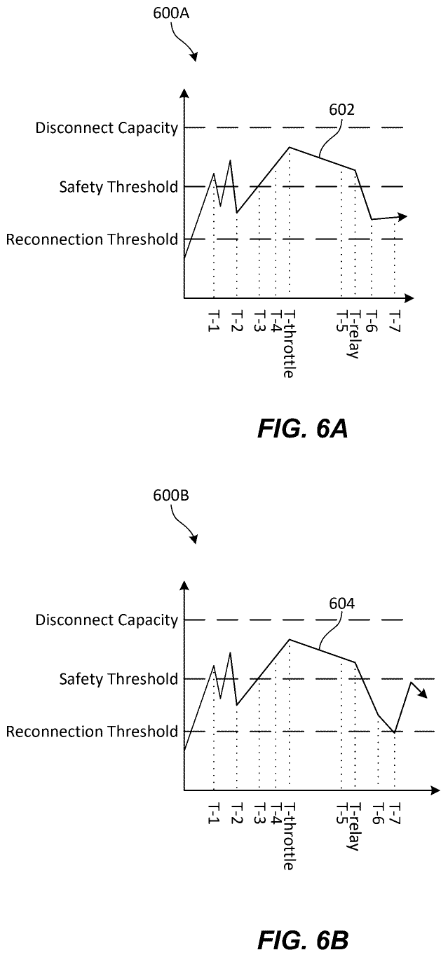

FIG. 6A is a plot 600A of current 602 over time in a first scenario, and FIG. 6B is a plot 600B of current 604 over time in a second scenario, according to embodiments of the present disclosure.

The plot 600A of FIG. 6A illustrates the first scenario in which current 602 is controlled by an electrical power control system as described below. The system may include a main electrical connection to a disconnect panel, and ultimately to associated electrical devices, and an auxiliary electrical connection to an auxiliary device. The current 602 shown in the plot 600A represents a total current through the main electrical connection and through the auxiliary electrical connection.

Initially, current usage rises from a relatively lower value to a value above a predetermined safety threshold at time T-1. At this time T-1, a multi-check process, such as the multi-check process 528 described above with reference to FIG. 5, may be initiated. After determining that the total current has reached or exceeded the predetermined safety threshold at time T-1, the system may wait a period of time to ensure that the current 602 remains above the predetermined safety threshold until a time T-2. In the first scenario, the current 602 drops below the predetermined safety threshold at the time T-2. The system continues waiting a predetermined time (e.g., t seconds) and checking periodically to determine whether the current 602 remains below the safety threshold and/or reconnection threshold or remains above the safety threshold for a sufficient time to take action. For example, at time T-3, the system may determine that the current 602 has risen above the safety threshold again. The system waits again before taking action, and checks the level of the current 602 at time T-4, finding that the current 602 remains above the safety threshold. After these multiple (e.g., two) consecutive determinations that the current 602 is above the safety threshold, the system instructs the auxiliary device to throttle (e.g., reduce) its power consumption at time T-throttle, which is a short inherent delay after the determination at time T-4.

The system then allows the auxiliary device to throttle its power usage until time T-5 to determine whether the throttling was sufficient to bring the current 602 below the predetermined safety threshold and/or the predetermined reconnection threshold. In the first scenario, at time T-3 the system finds that the current 602 remains above the predetermined safety threshold. Therefore, immediately after time T-3 (e.g., not waiting any predetermined time period but possibly after a short inherent delay), the system causes a relay coupled to an auxiliary electrical connection to the auxiliary device to open at time T-relay.

In the first scenario, the total current 602 then drops to a value between the predetermined safety threshold and the predetermined reconnection threshold as sensed by the system at time T-6. The system continues to monitor the current 602 at time T-5 when the current 602 is still above the predetermined reconnection threshold but below the predetermined safety threshold. The system will continue to monitor the current 602 and keep the relay open (and, therefore, stop flow of current to the auxiliary device) until a later time when the current 602 may drop below the predetermined reconnection threshold. The system will cause the relay to close again immediately after the current 602 drops below the predetermined reconnection threshold, restoring full power to the auxiliary device. Alternatively, if the current 602 reaches a level to exceed the capacity of a disconnect (e.g., a breaker, a fuse, etc.) even with the auxiliary device shut off by the relay, the disconnect may interrupt the current 602 as a final failsafe. The capacity of the disconnect may be above the predetermined safety threshold, such as at or near a maximum ampacity rating of the system as a whole. The system may reduce instances of the disconnect tripping by opening the relay to the auxiliary device as the total current 602 approaches or remains close to the disconnect capacity, as described above.

In the second scenario illustrated in the plot 600B of FIG. 6B, the current 604 and system may function in the same or a similar way to current 602 and system in the first scenario through time T-6, as described above. In the second scenario, however, after time T-6 the current 604 may drop until it reaches the predetermined reconnection threshold at time T-7. Upon determining that the current 604 has reached the predetermined reconnection threshold at time T-7, the system may immediately close the relay to allow current to flow to the auxiliary device. As illustrated in FIG. 6B, the total current 604 may rise after the relay is closed at time T-7 as the auxiliary device again draws power. Since a difference between the predetermined safety threshold and the predetermined reconnection threshold may be larger than the maximum ampacity rating of the auxiliary device, the current 604 may not immediately reach the predetermined safety threshold as a direct result of the reconnection of the auxiliary device.

If the current 604 does eventually reach the predetermined safety threshold again, such as from additional loads drawing more current from the system, the process of reading the current 604 and confirming that the current 604 is above the predetermined safety threshold multiple consecutive times before opening the relay to the auxiliary device may be repeated. Alternatively, if the current 604 remains below the predetermined safety threshold, the relay to the auxiliary device may remain closed to continue supplying power to the auxiliary device.

As described above, FIGS. 6A and 6B illustrate two example scenarios that may occur to demonstrate how the electrical power control system may react current levels to control electrical current flow. Many additional scenarios may exist, depending on the types and presence of electrical loads, usage of a particular system, user settings, or other factors.

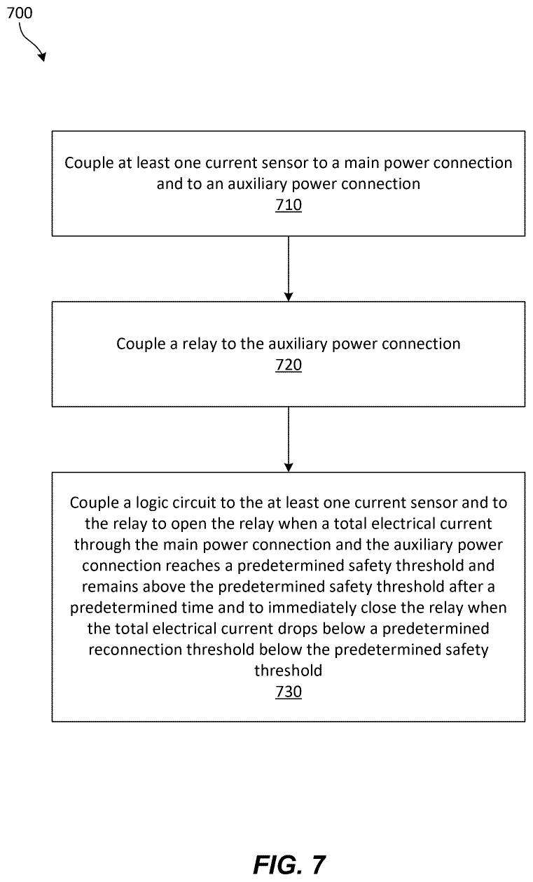

FIG. 7 is a flow diagram illustrating a method 700 of forming an electrical power control device, according to at least one embodiment of the present disclosure.

At operation 710, at least one current sensor may be coupled to a main power connection for transmitting electrical power from a meter socket to a disconnect panel and to an auxiliary power connection for transmitting electrical power from the meter socket to an auxiliary device. For example, the at least one current sensor may include a main current sensor coupled to the main power connection and an auxiliary current sensor coupled to the auxiliary power connection.

At operation 720, a relay may be coupled to the auxiliary power connection. For example, the relay may be configured to open to stop flow of electrical current through the auxiliary power connection and to close to allow flow of electrical current through the auxiliary power connection.

At operation 730, a logic circuit (e.g., a logic circuit implemented via digital logic gates without a controller or a logic circuit implemented via a controller) may be coupled to the at least one current sensor and to the relay. The logic circuit may be configured to open the relay (e.g., if the relay is previously closed) when a total electrical current through the main power connection and the auxiliary power connection reaches a predetermined safety threshold and remains above the predetermined safety threshold after a predetermined time (e.g., less than one minute, less than 10 seconds, less than 5 seconds, etc.). The logic circuit may also be configured to immediately close the relay (e.g., if the relay is previously open) when the total electrical current drops below a predetermined reconnection threshold below the predetermined safety threshold.

In some examples, the term “about” in reference to a given parameter, property, or condition, may refer to a degree that one skilled in the art would understand that the given parameter, property, or condition is met with a small degree of variance, such as within acceptable manufacturing tolerances and/or conventional measurement techniques. For example, a parameter that is “about” met may be at least about 90% met, at least about 95% met, at least about 99% met, or fully met.

Accordingly, the present disclosure includes devices, systems, and methods that may be useful for managing electrical power usage in systems that include a main power branch (e.g., to a disconnect panel) and one or more auxiliary power branches (e.g., to one or more auxiliary devices). These concepts may be employed to automatically shut off or reconnect power to one or more auxiliary devices when electrical current thresholds are met to reduce the chance of disconnects tripping during periods of high electricity usage.

The following example embodiments are also included in the present disclosure.

Example 1. An electrical power control device, including: a main power connection for transmitting electrical power to a disconnect panel; an auxiliary power connection for transmitting electrical power to an auxiliary device; at least one current sensor configured to sense a total electrical current passing through the main power connection and the auxiliary power connection; and a relay coupled to the auxiliary power connection, wherein the relay is configured to: open to stop flow of auxiliary electrical current through the auxiliary power connection after the total electrical current is above a predetermined safety threshold; and close to allow flow of the electrical current through the auxiliary power connection immediately after the total current reaches a predetermined reconnection threshold lower than the predetermined safety threshold.

Example 2. The device of Example 1, wherein the relay is configured to open after: waiting a predetermined time after the total electrical current is above the predetermined safety threshold; and after waiting the predetermined time, the total electrical current is still above the predetermined safety threshold.

Example 3. The device of Example 2, wherein the predetermined time is less than one minute.

Example 4. The device of Example 2 or Example 3, wherein the predetermined time is less than 10 seconds.

Example 5. The device of any one of Examples 1 through 4, further including a logic circuit connected to the at least one current sensor and the relay, the logic circuit being configured to selectively cause the relay to open and close based on data from the at least one current sensor.

Example 6. The device of Example 5, wherein the logic circuit includes digital logic gates implemented without a controller.

Example 7. The device of Example 5, wherein the logic circuit is implemented via a controller programmed to receive data from the at least one current sensor and to control operation of the relay.

Example 8. The device of any one of Examples 1 through 5 or 7, further including a controller configured to: receive data from the at least one current sensor indicative of the total electrical current; instruct the auxiliary device to reduce its power consumption after the total electrical current is above the predetermined safety threshold and prior to the relay opening to stop the flow of the auxiliary electrical current through the auxiliary power connection; and cause the relay to open and close based on the data indicative of the total electrical current.

Example 9. The device of any one of Examples 1 through 8, wherein the at least one current sensor includes: a main current sensor coupled to the main power connection for sensing electrical current passing through the main power connection; and an auxiliary current sensor coupled to the auxiliary power connection for sensing electrical current passing through the auxiliary power connection.

Example 10. The device of any one of Examples 1 through 9, wherein a difference between the predetermined safety threshold and the predetermined reconnection threshold is greater than a maximum ampacity rating of the auxiliary power connection.

Example 11. The device of any one of Examples 1 through 10, further including a housing containing the at least one current sensor and the relay.

Example 12. The device of Example 11, wherein the housing further contains a meter socket.

Example 13. The device of Example 11, wherein the housing is mounted external to a meter socket supplying electrical power to the electrical power control device.

Example 14. The device of any one of Examples 1 through 13, wherein the auxiliary device includes at least one of: an electric vehicle charging station; an electric vehicle; a pump; an air conditioning unit; a heater; or a refrigerator.

Example 15. The device of any one of Examples 1 through 14, wherein the disconnect panel includes at least one of: a residential breaker panel; a commercial breaker panel; a fuse box; a fusible switch box; or a protective relay panel.

Example 16. An electrical power control system, including: at least one current sensor configured to sense a total electrical current passing through a main power connection to a disconnect panel and an auxiliary power connection to an auxiliary device; a relay coupled to the auxiliary power connection; and a logic circuit, wherein the logic circuit is configured to: perform a first comparison to determine whether the total electrical is equal to or greater than a predetermined safety threshold; when the total electrical current is equal to or greater than the predetermined safety threshold, wait a predetermined time; after the predetermined time, perform a second comparison to determine whether the total electrical current is equal to or greater than the predetermined safety threshold; and when the second comparison determines that the total electrical current is equal to or greater than the predetermined safety threshold, open or keep open the relay to stop flow of electrical current to the auxiliary device.

Example 17. The system of Example 16, wherein the logic circuit is further configured to: when the second comparison determines that the total electrical current does not meet or exceed the predetermined safety threshold, perform a third comparison to determine whether the total electrical current is less than or equal to a predetermined reconnection threshold less than the predetermined safety threshold; and when the third comparison determines that the total electrical current is equal to or less than the predetermined reconnection threshold, close or keep closed the relay to allow flow of electrical current to the auxiliary device.

Example 18. The system of Example 16 or Example 17, wherein the predetermined time is less than one minute.

Example 19. The system of any one of Examples 16 through 18, wherein the logic circuit is implemented via one of: digital logic gates without a controller; or a controller programmed to receive data from the at least one current sensor and to control operation of the relay.

Example 20. A method of forming an electrical power control device, the method including: coupling at least one current sensor to a main power connection for transmitting electrical power from a meter socket to a disconnect panel and to an auxiliary power connection for transmitting electrical power from the meter socket to an auxiliary device; coupling a relay to the auxiliary power connection; and coupling a logic circuit to the at least one current sensor and to the relay, wherein the logic circuit is configured to: open the relay when a total electrical current through the main power connection and the auxiliary power connection reaches a predetermined safety threshold and remains above the predetermined safety threshold after a predetermined time; and immediately close the relay when the total electrical current drops below a predetermined reconnection threshold below the predetermined safety threshold.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An electrical power control device, comprising:
a main power connection for transmitting electrical power to a disconnect panel;
an auxiliary power connection for transmitting electrical power to an auxiliary device;
at least one current sensor configured to sense a total electrical current passing through the main power connection and the auxiliary power connection; and
a relay coupled to the auxiliary power connection, wherein the relay is configured to:
open to stop flow of auxiliary electrical current through the auxiliary power connection after the total electrical current is above a predetermined safety threshold; and
close to allow flow of the electrical current through the auxiliary power connection immediately after the total current reaches a predetermined reconnection threshold lower than the predetermined safety threshold.

2. The device of claim 1, wherein the relay is configured to open after:
waiting a predetermined time after the total electrical current is above the predetermined safety threshold; and
after waiting the predetermined time, the total electrical current is still above the predetermined safety threshold.

3. The device of claim 2, wherein the predetermined time is less than one minute.

4. The device of claim 2, wherein the predetermined time is less than 10 seconds.

5. The device of claim 1, further comprising a logic circuit connected to the at least one current sensor and the relay, the logic circuit being configured to selectively cause the relay to open and close based on data from the at least one current sensor.

6. The device of claim 5, wherein the logic circuit comprises digital logic gates implemented without a controller.

7. The device of claim 5, wherein the logic circuit is implemented via a controller programmed to receive data from the at least one current sensor and to control operation of the relay.

8. The device of claim 1, further comprising a controller configured to:
receive data from the at least one current sensor indicative of the total electrical current;
instruct the auxiliary device to reduce its power consumption after the total electrical current is above the predetermined safety threshold and prior to the relay opening to stop the flow of the auxiliary electrical current through the auxiliary power connection; and
cause the relay to open and close based on the data indicative of the total electrical current.

9. The device of claim 1, wherein the at least one current sensor comprises:
a main current sensor coupled to the main power connection for sensing electrical current passing through the main power connection; and
an auxiliary current sensor coupled to the auxiliary power connection for sensing electrical current passing through the auxiliary power connection.

10. The device of claim 1, wherein a difference between the predetermined safety threshold and the predetermined reconnection threshold is greater than a maximum ampacity rating of the auxiliary power connection.

11. The device of claim 1, further comprising a housing containing the at least one current sensor and the relay.

12. The device of claim 11, wherein the housing further contains a meter socket.

13. The device of claim 11, wherein the housing is mounted external to a meter socket supplying electrical power to the electrical power control device.

14. The device of claim 1, wherein the auxiliary device comprises at least one of:
an electric vehicle charging station;
an electric vehicle;
a pump;
an air conditioning unit;
a heater; or
a refrigerator.

15. The device of claim 1, wherein the disconnect panel comprises at least one of:
a residential breaker panel;
a commercial breaker panel;
a fuse box;
a fusible switch box; or
a protective relay panel.

16. An electrical power control system, comprising:
at least one current sensor configured to sense a total electrical current passing through a main power connection to a disconnect panel and an auxiliary power connection to an auxiliary device;
a relay coupled to the auxiliary power connection; and
a logic circuit, wherein the logic circuit is configured to:
perform a first comparison to determine whether the total electrical is equal to or greater than a predetermined safety threshold;
when the total electrical current is equal to or greater than the predetermined safety threshold, wait a predetermined time;
after the predetermined time, perform a second comparison to determine whether the total electrical current is equal to or greater than the predetermined safety threshold; and
when the second comparison determines that the total electrical current is equal to or greater than the predetermined safety threshold, open or keep open the relay to stop flow of electrical current to the auxiliary device.

17. The system of claim 16, wherein the logic circuit is further configured to:
when the second comparison determines that the total electrical current does not meet or exceed the predetermined safety threshold, perform a third comparison to determine whether the total electrical current is less than or equal to a predetermined reconnection threshold less than the predetermined safety threshold; and
when the third comparison determines that the total electrical current is equal to or less than the predetermined reconnection threshold, close or keep closed the relay to allow flow of electrical current to the auxiliary device.

18. The system of claim 16, wherein the predetermined time is less than one minute.

19. The system of claim 16, wherein the logic circuit is implemented via one of:
digital logic gates without a controller; or
a controller programmed to receive data from the at least one current sensor and to control operation of the relay.

20. A method of forming an electrical power control device, the method comprising:
coupling at least one current sensor to a main power connection for transmitting electrical power from a meter socket to a disconnect panel and to an auxiliary power connection for transmitting electrical power from the meter socket to an auxiliary device;
coupling a relay to the auxiliary power connection; and
coupling a logic circuit to the at least one current sensor and to the relay, wherein the logic circuit is configured to:
open the relay when a total electrical current through the main power connection and the auxiliary power connection reaches a predetermined safety threshold and remains above the predetermined safety threshold after a predetermined time; and
immediately close the relay when the total electrical current drops below a predetermined reconnection threshold below the predetermined safety threshold.
